(19) United States
(12) Patent Application Publication
(10) Pub. No.: US 2006/0154652 A1
(43) Pub. Date: Jul. 13, 2006

(54) Method and system for direct communication between mobile device and application on display

(75) Inventors: Yong Lee, Yongin-si (KR); Woo-shik Kang, Suwon-si (KR); Si-gyong Koo, Seoul (KR); Hyung-min Yoon, Seoul (KR); Kyung-ho Park, Suwon-si (KR); Ji-hun Koo, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electro-Mechanics Co., Ltd.

(21) Appl. No.: 11/324,300

(22) Filed: Jan. 4, 2006

(30) Foreign Application Priority Data
Jan. 11, 2005 (KR) 2005-2422

(51) Int. Cl. H04Q 7/22

(52) U.S. Cl. 455/414.4

(57) ABSTRACT

A method and apparatus for reducing the number of manipulations by a user during the data communication between an information device and a mobile device. The communication is performed with a data communication system that includes a mobile device; a display for displaying a position of the mobile device sensed using a provided position sensor and transferring data corresponding to the displayed position to the mobile device or data stored in the mobile device to the displayed position; and an information device for transceiving data with the display.

### CROSS-REFERENCE TO RELATED APPLICATIONS

This application claims the benefit under 35 U.S.C. §119 (a) from Korean Patent Application No. 2005-02422 filed on Jan. 11, 2005 in the Korean Intellectual Property Office, the entire disclosure of which is incorporated herein by reference.

### BACKGROUND OF THE INVENTION

1. Field of the Invention

The present invention relates generally to communications between a mobile device and an application on a display. More particularly, the present invention relates to direct communications between a mobile device and an application on a display.

2. Description of the Related Art

A personal computer (PC) displays data on its display so that a user can view the data output from the PC. The user can request to transfer desired data from the PC to a mobile device.

FIG. 1 illustrates a PC 100 and a mobile device 110 communicating with the PC 100 in the related art. Referring to FIG. 1, the PC 100 includes a display 102, an input device 108, a controller 104, and a communication module 106. Typically, the display 102 may be equipped as a separate device. To facilitate the understanding of the present invention, it is illustrated in FIG. 1 that the display 102 is built in the PC 100.

The input device 108 receives required information from the user. Primarily, the input device 108 can be implemented as a keyboard, a mouse, and the like. In addition, the input device 108 wirelessly transmits required information to the controller 104 via a remote controller.

The controller 104 executes operations corresponding to the received information, and issues control commands to the components of the PC 100 to control them. The display 102 displays required information according to the control command of the controller 104. The communication module 106 communicates with the mobile device 110 according to the control command. The communication module communicates data with the mobile device by wireless or wired connection. Non-limiting examples of the wireless communication include Bluetooth and infrared transmission.

The mobile device 110 transmits or receives required data to or from the PC 100 by the wired or wireless connection. For example, the mobile device 110 receives video or audio information stored in the PC 100, or transmits its stored video or audio information to the PC 100.

The communications between the mobile device 110 and the PC 100 are carried out using the input device 108. The user receives or transfers data from or to the mobile device 110 using the input device 108. For example, video data stored in the mobile device 110 is transferred to the PC 100 by the wired connection, to be described.

To transfer the video data from the mobile device 110 to the PC 100, the mobile device 110 is connected to the PC 100 by the wired connection. Generally, a universal serial bus (USB) cable is used to interconnect the mobile device 110 and the PC 100. The PC 100 loads a relevant application and reads the read data from the mobile device 110 in the loaded application.

As such, the delivery of the data between the mobile device 110 and the PC 100 is performed through the manipulation of the input device 108. In this regard, a method is needed to enable the data communications between the PC 100 and the mobile device 110 without the manipulation of the input device 108 of the PC 100.

### SUMMARY OF THE INVENTION

The present invention has been provided to solve the above-mentioned and other problems and disadvantages occurring in the conventional arrangement, and an aspect of the present invention provides a method for reducing the number of manipulations by a user for data communications between a PC and a mobile device.

Another aspect of the present invention provides a method for communicating data between a mobile device and a PC without constraints on a location of the communication.

To achieve the above aspects and/or features of the present invention, a method for communicating data between a mobile device and an information device in a communication system including the mobile device and the information device, the information device to which a display is externally equipped for communicating with the mobile device, includes displaying, by the display having a position sensor, a position of the sensed mobile device; and transferring data corresponding to the displayed position to the mobile device or data stored in the mobile device to the corresponding position.

In accordance with the above aspects of the present invention, a data communication system includes a mobile device; a display for displaying a position of the mobile device sensed using a provided position sensor and transferring data corresponding to the displayed position to the mobile device or data stored in the mobile device to the displayed position; and an information device for transceiving data with the display.

### BRIEF DESCRIPTION OF THE DRAWING FIGURES

These and/or other aspects and advantages of the invention will become apparent and more readily appreciated from the following description of exemplary embodiments, taken in conjunction with the accompanying drawing figures of which:

FIG. 1 is a block diagram of a mobile device and a PC for data communications;

FIG. 2 illustrates a construction of a display according to an embodiment of the present invention;

FIG. 3 is a block diagram of the display and a mobile device according to an embodiment of the present invention;

FIG. 4 is a diagram illustrating data communications between the display and the mobile device according to an embodiment of the present invention; and

FIG. 5 is a diagram illustrating data communications between the display and the mobile device according to an embodiment of the present invention.

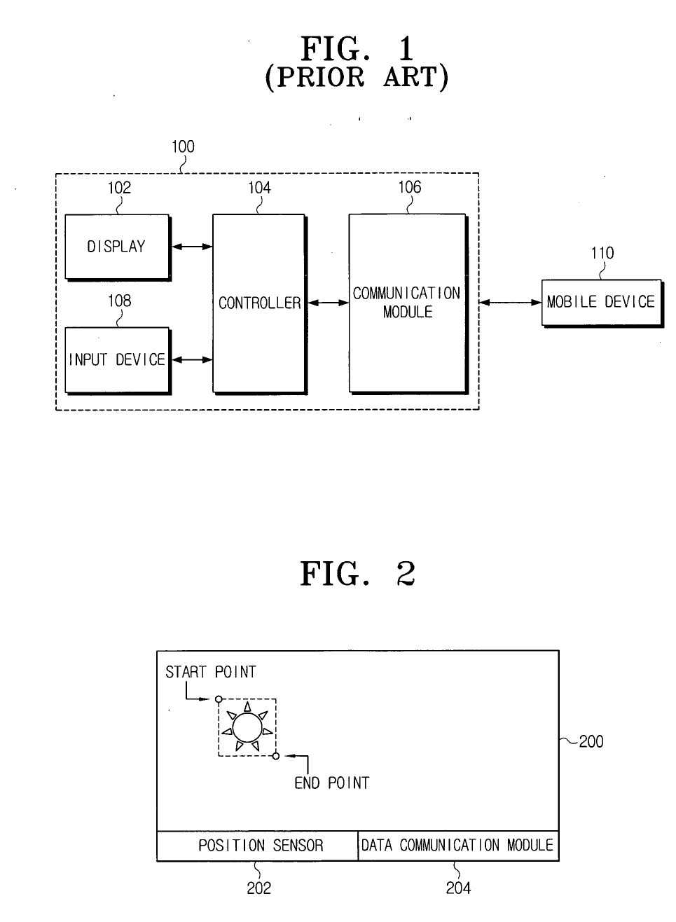

### DETAILED DESCRIPTION OF THE EMBODIMENTS

Certain exemplary embodiments of the present invention will now be described in greater detail with reference to the accompanying drawings.

In the following description, same drawing reference numerals are used for the same elements even in different drawings. Certain matters defined in the description, such as detailed construction and element descriptions, are provided to assist in a comprehensive understanding of the invention. Also, well-known functions or constructions are not described in detail since they would obscure the invention in unnecessary detail.

Hereafter, descriptions are provided of a method for communicating data between a mobile device and an information device that includes a separate input section according to an embodiment of the present invention in reference to the attached drawings.

FIG. 2 depicts a display of the information device, which includes a separate input section according to an embodiment of the present invention. Note that the information device can be not only a stationary information device such as a desktop PC but also a mobile information device such as a notebook. Non-limiting examples of the information device include stationary and mobile information devices that have a separate input section. The display may be built into the information device or equipped as a separate device.

According to an embodiment of the present invention, a mobile device and the display 200 perform direct communication. To this end, the display 200 includes a communication module responsible for communication with the mobile device. Referring to FIG. 2, the display 200 includes a position sensor 202 and a data communication module 206.

The position sensor 202 detects a position of the mobile device. Upon acquiring the position of the mobile device, the position sensor 202 drives the data communication module 204. Specifically, the position sensor 202 determines whether the mobile device is placed within a range where direct communication with the data communication module 204 is feasible. When the mobile device is located within the range of direct communication with the data communication module 204, the position sensor 202 provides information relating to the position of the mobile device to a controller. Generally, the controller is built into the information device.

The controller, upon receiving the information from the position sensor 202, issues a control command to the data communication module 204 to drive the data communication module 204. Upon receiving the control command from the controller, the data communication module 204 drives to communicate with the mobile device. Therefore, it is possible to minimize the power consumed by the data communication module 204.

FIG. 2 depicts an image displayed on the display 200. The mobile device can capture and store the displayed image (data) therein, or transfer its stored data to the display 200.

To store the displayed image, the mobile device needs to define an image area to be captured and read data corresponding to the defined area. As shown in FIG. 2, the area to be captured is defined with a start point and an end point. The following description describes how the mobile device captures the displayed image.

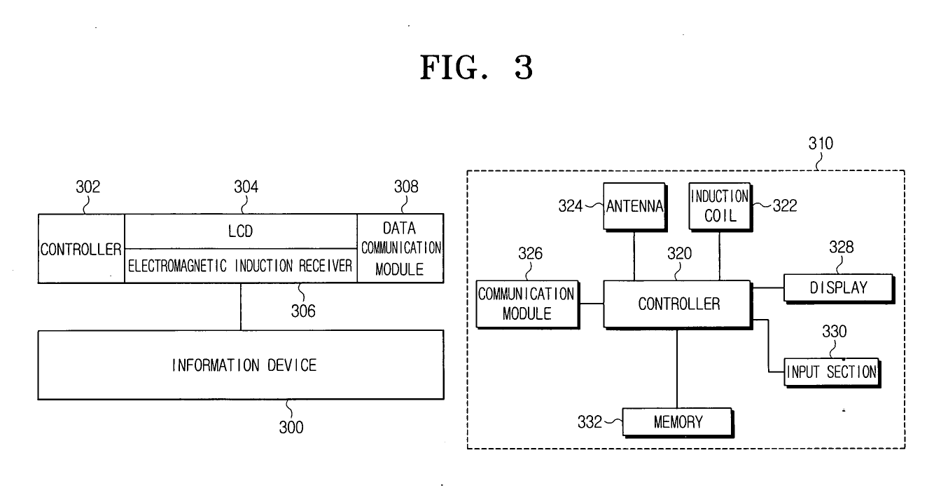

To do this, the principle of a digital pen is adopted in the embodiment of the present invention. FIG. 3 illustrates a display and a mobile device according to an embodiment of the present invention.

The display 200 includes a liquid crystal display (LCD) 304, an electromagnetic induction receiver 306, a controller 302, and a data communication module 308. The mobile device 310 includes an antenna 324, an induction coil 322, a communication module 326, a controller 320, a display 328, an input section 330, an input section 330 and a memory 332. According to an embodiment of the present invention, the principle of the digital pen is employed to acquire the position of the mobile device 310. The digital pen operates according to an electromagnetic induction technology. Hereafter, the principle of the digital pen is explained.

When the digital pen forming a magnetic field touches the LCD 304 or is positioned at a specific distance away from the LCD 304, the LCD 304 detects the position of the digital pen by receiving the magnetic energy. Since the LCD 304 does not operate around digital pens other than the dedicated digital pen, erroneous operations can be prevented. Also, the LCD 304 is able to detect the position of the digital pen at a distance if the magnetic energy can reach.

The components of the display and the mobile device in FIG. 3 are elucidated below in that order.

The controller 302 controls operations of the components of the display. The LCD 304 displays data fed from the information device 300. In addition, the LCD 304 displays information relating to the position of the mobile device 310. Specifically, the LCD 304 displays the position of the mobile device 310 using a cursor. The electromagnetic induction receiver 306 detects the position of the mobile device 310. As aforementioned, the position of the mobile device 310 is acquired by use of the change of the magnetic energy exerted from the induction coil 322 of the mobile device 310. The information relating to the acquired position of the mobile device 310 is fed to the controller 302.

The data communication module 308 communicates data with the mobile device 310. In detail, the data communication module 308 transfers data displayed on the LCD 304 to the mobile device 310, or transfers data stored in the mobile device 310 to the display. The information device 300 is responsible to control overall operations of the display.

The antenna 324 of the mobile device 310 transceives data with another mobile device or a base station. The induction coil 322 generates a magnetic field. The electromagnetic induction receiver 306 uses the change of the magnetic field to acquire the position of the mobile device 310. The display 328 displays images or video stored in the mobile device 310 according to the control command of the controller 320. The input section 330 receives or requests required information from or to another mobile device to facilitate communication with the other mobile device. According to an embodiment of the present invention, the input section 330 requests to capture the data displayed on the LCD 304 or to transfer the captured data. The data capture or the data transfer can be requested by manipulating keys provided to the input section 330. The memory 332 holds information required to drive the mobile device 310, or stores data such as video and audio data according to a request from a user. The communication module 326 communicates with the data communication module 308 of the display. It has been illustrated that the position of the mobile device 310 is acquired using the change of the magnetic energy.

Note that the position of the mobile device 310 may be detected using other schemes in addition to the change of the magnetic energy. For example, a touch screen is used to acquire the position of the mobile device 310 that contacts the LCD 304. In this case, the LCD 304 requires capability to detect the contact of the mobile device 310. General types of touch screen include, for example, a resistive touch screen, an infrared touch screen, an ultrasonic wave touch screen, and a capacitive touch screen.

The resistive touch screen uses two conductive plates (conductive coating film and conductive coating glass) to acquire a position of an object by processing electrical contact occurring when pressure is exerted by a finger or a pen. The infrared touch screen uses an infrared sensor, which includes a light emitting element for generating an infrared light and a light receiving element for receiving the generated infrared light, to detect a position of an object based on the interruption of the infrared light by the object. The ultrasonic wave touch screen uses an ultrasonic wave oscillator. When the ultrasonic wave is oscillated on the touch screen panel at very short intervals, a receiver receives the ultrasonic wave and thus detects the position of an object. For example, when fingers or an object absorbing the acoustic wave touches the touch screen panel, the ultrasonic wave generated by the oscillator is partially absorbed by the object and only the remaining wave is fed to the receiver to thus detect the position of the object. The capacitive touch screen acquires the position of an object based on a change of electrical charges on the touch screen panel. In principle, the capacitive touch screen selectively operates with respect to an electric conductor that responds to the amount of the charges.

The position of the mobile device can be acquired according to other technologies besides those mentioned above.

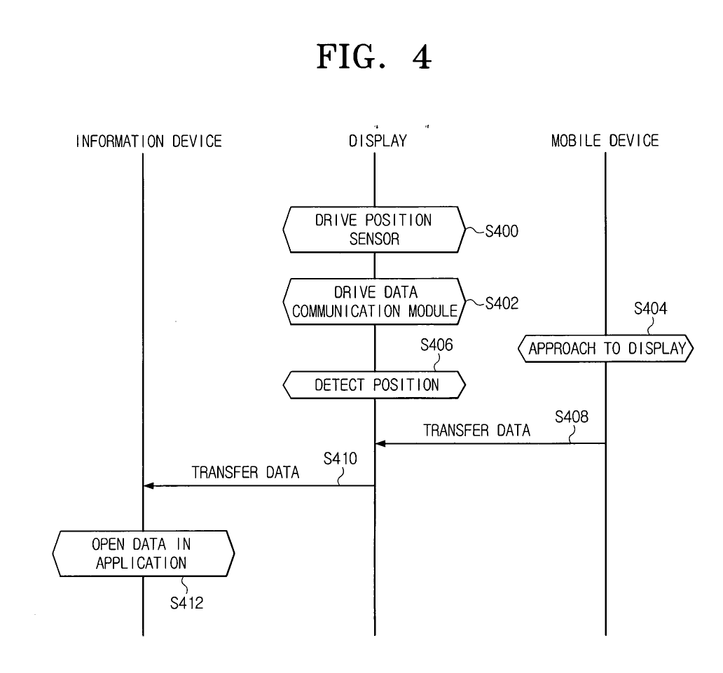

FIG. 4 is a diagram illustrating the direction communications between the mobile device and the display according to an embodiment of the present invention, to be elucidated below. Particularly, FIG. 4 shows how the mobile device transfers its stored data to the display.

The display drives the position sensor (S400). The display drives its data communication module (S402). The mobile device approaches the display (S404). As shown in FIG. 4, the data communication module is driven prior to the approach of the mobile device to the display. It should be appreciated that when to drive the data communication module is changeable according to a preference of a user.

The display detects and acquires the position of the mobile device (S406). Thus, the display displays information relating to the acquired position of the mobile device on the LCD. The mobile device transfers the data to the display (S408). The display provides the received data to the information device (S410). The information device opens the received data in the application, that is, in the execution program (S412).

As an example, when the mobile device transfers audio data to the display while the mobile device is positioned within the execution program, displayed on the display, relating to the audio reproduction, the information device opens the received audio data in the execution program. When the mobile device transfers video data to the display while the mobile device is positioned within the execution program, displayed on the display, relating to the video reproduction, the information device opens the received video data in that execution program. Table 1 shows examples of data stored in the memory of the mobile device.

TABLE 1

| | |
|---|---|
| Audio data | first audio data, second audio data, . . . |
| Image data | first image data, second image |
| | data, . . . |
| Video data | first video data, second video data, . . . |
| . . . | . . . |

As such, the user can open the audio data or the video data stored in the mobile device without having to separately load the execution program. That is, the data stored in the mobile device can be opened from the display of the execution program of the information device through simple key manipulation.

Authentication based on importance of the data transferred from the mobile device can be performed before the data is transferred. The authentication between the mobile device and the information device is carried out by transferring authentication data from the mobile device to the display.

Hence, data security can be enhanced with the authentication on the data of the high-level importance, and efficiency of the data transfer can be enhanced by skipping the authentication on data of low-level importance.

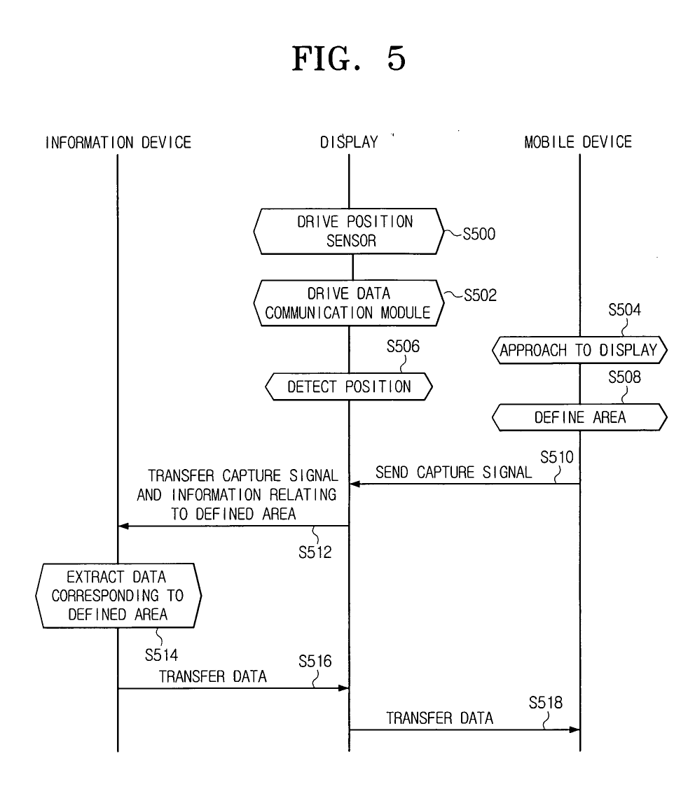

FIG. 5 is a diagram illustrating direct communications between the display and the mobile device according to an embodiment of the present invention. Particularly, FIG. 5 illustrates how to transfer data stored in the information device to the mobile device.

The display drives the position sensor (S500) and the data communication module (S502). The mobile device approaches the display (S504). As mentioned earlier, it is illustrated in FIG. 4, similarly to FIG. 5, that the data communication module is driven before the mobile device approaches the display. It is noted that when to drive the data communication module is changeable according to a preference of the user.

The display detects (acquires) the position of the mobile device (S506). Next, the display displays information relating to the acquired position of the mobile device on the LCD. The mobile device defines a data area to be captured based on the information displayed on the LCD (S508). The mobile device sends a capture signal to the display (S510). The capture signal requests the data corresponding to the captured area. The display forwards the capture signal to the information device (S512). At the same time, the display sends the information relating to the defined area to the information device (S512).

The information device extracts the data corresponding to the defined area (S514). The information device sends the extracted data to the display (S516). The display forwards the received data to the mobile device (S518). As a result, the mobile device obtains the intended data.

Although it is illustrated in FIG. 3 that only one mobile device communicates with the display, at least two mobile devices can communicate with the display. In this situation, the respective mobile devices independently communicate with the display.

The information device may store ID information pertaining to mobile devices capable of directly communicating with the display. Accordingly, the priority of the mobile devices can be determined based on the stored information when at least two mobile devices request the data communication.

As noted above, the mobile device can directly communicate with the display that displays video according to the control command of the information device. Data stored in the mobile device can be transferred to the information device with simple key manipulation, or data stored in the information device can be received from the information device with simple key manipulation. Therefore, the user transceives intended data regardless of the location.

As for the information device, the intended data can be provided to the user using only the display. In this respect, it is possible to reduce the complexity and the maintenance cost of the system with the usage of a keyboard, a mouse, a communication cable, and the like.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method for communicating data between a mobile device and an information device in a communication system including the mobile device and the information device, the information device to which a display is externally equipped for communicating with the mobile device, the method comprising:
displaying, by the display having a position sensor, a position of the sensed mobile device; and
transferring data corresponding to the displayed position to the mobile device or data stored in the mobile device to the corresponding position.

2. The method of claim 1, wherein the position of the mobile device is acquired using a touch screen technology or an electromagnetic induction technology.

3. The method of claim 1, wherein, when the data stored in the mobile device is transferred to the display, the data is opened using an execution program displayed on the corresponding position.

4. The method of claim 1, wherein the transferring of the data corresponding to the displayed position to the mobile device comprises:
requesting data corresponding to a defined area from the mobile device;
requesting the requested data to the information device and receiving the requested data; and
transferring the received data to the mobile device.

5. The method of claim 4, wherein information relating to the defined area and data corresponding to the defined area are requested to the information device.

6. A data communication system comprising:
a mobile device;
a display configured to display a position of the mobile device sensed using a provided position sensor and transferring data corresponding to the displayed position to the mobile device or data stored in the mobile device to the displayed position; and
an information device for transceiving data with the display.

7. The data communication system of claim 6, wherein the position sensor is a digital pen operating according to a touch screen technology or an electromagnetic induction technology.

8. The data communication system of claim 6, wherein the display comprises:
a data communication module configured to communicate with the mobile device.

9. The data communication system of claim 6, wherein the mobile device comprises:
a data communication module configured to communicate with the display.

10. The data communication system of claim 6, wherein the information device, when the data stored in the mobile device is transferred to the display, opens the received data in an execution program displayed at the corresponding position.

11. The data communication system of claim 6, wherein the mobile device performs authentication with the information device via the display by use of inherent identifiers.
